(19) United States
(12) Patent Application Publication
(10) Pub. No.: US 2001/0034674 A1
(43) Pub. Date: Oct. 25, 2001

(54) Sample shipping and storing apparatus and method

(76) Inventor: Roger P. Hoffman, Green Bay, WI (US)

Correspondence Address: WEISS & WEISS, 500 Old Country Road, Suite 305, Garden City, NY, 11530, US

(21) Appl. No.: 09/837,056

(22) Filed: Apr. 18, 2001

Related U.S. Application Data
(60) Provisional application No. 60/198,546, filed on Apr. 19, 2000.

(51) Int. Cl. G06F 17/60

(52) U.S. Cl. 705/28; 705/1

(57) ABSTRACT

The present invention relates to a method and system for storing, delivering and tracking samples.

### FIELD OF THE INVENTION

The present invention relates to a method and system for storing, delivering and tracking samples.

### BACKGROUND OF THE INVENTION

Typically, when a salesman is on the road selling goods for a company, the salesman usually bring the samples of the goods to show the potential buyer. If the salesman did not have samples of the goods available, the ability of the salesman to successfully complete a transaction would be severely compromised. Therefore, having the ability to provide samples in a timely and efficient manner is an important consideration in one's ability to complete transactions. There is a complexity that is involved when a company is selling multiple products from multiple corporations to a very geographically diverse Market.

This situation is exactly what exists when products are sold via an exchange via the Internet. When products are sold over the Internet a customer cannot see what they are buying at best they see an electronic representation of what the product looks like. Although, electronic images of the product can be obtained over the Internet, for many transactions it is necessary to see a sample of the goods. With the emergence of the Internet a salesman or Internet exchange may represent a number of companies each located at different areas across the country or across the world. It is not practical for a salesman to contact each of the locations where the products are made to send samples to the customers. This process is timely, and costs the salesman sales.

### SUMMARY OF THE INVENTION

The present invention relates to a method and system for storing, delivering and tracking samples. It is an object of the present invention to provide a method and system for sending samples to a customer who is interested in purchasing a product over the Internet.

The present invention relates to a system for storing samples from multiple manufacturing locations comprising a warehouse or facility for storing samples of goods. The facility stores perishable samples and provides appropriate environmental conditions necessary to keep the samples viable. The facility also has a database for storing information concerning the characteristics of the sample.

It is an object of the present invention to provide a facility or warehouse for storing samples of goods. It is a further object of the invention to provide this facility near a transportation hub such as a Federal Express or UPS delivery center. It is an object of the present invention to provide a facility, which can store perishable samples, and to provide the correct humidity, temperature, and other environmental factors, which are necessary to keep the samples viable.

It is an object of the present invention to store information regarding the sample, including the origin of the sample, date of arrival of the sample at the facility, date the sample was created, and conditions for keeping the sample viable. It is an object of the present invention to provide an expiration date for the samples.

It is an object of the present invention to provide a notification system, which notifies a user when samples are no longer viable because they have been kept at the facility beyond a certain time frame.

It is an object of the invention to provide a system for continued replenishment of samples so that the facility has a supply of samples at hand at all times. It is an object of the present invention to keep a count of the number of samples stored at the facility of a particular good from a specific customer. When the number of samples is below a specific number, the company is contacted to replenish the samples.

It is an object of the present invention to provide samples in bulk to the facility and to be able to breakup or cut the product into individual samples for distribution.

It is an object of the present invention to track the location of the samples and to provide sufficient information to a customer about the content and origin of the sample.

The present invention relates to a computer system for samples comprising; a database which comprises information of each sample. The database contains information regarding the number of samples from a particular supplier of a particular type. It is a farther object of the present invention for the system to inform a user to order more samples when the number of samples from a particular supplier of a particular good are less than a particular number of samples. It is a further object of the present invention to provide software for tracking the location of the samples. It is an object of the present invention for the information concerning the samples to comprise the origin of the sample, date of arrival of the sample to the facility, date the sample was produced, and conditions for keeping the sample viable.

The present invention relates to a method for storing samples comprising; providing identification numbers to each sample, storing information about the samples, sending the sample to the customer along with information about the sample and tracking delivery of the sample from a facility where the sample is stored to a final destination.

### DETAILED DESCRIPTION OF THE INVENTION

In a preferred embodiment, the present invention comprises a system for storing, delivering and tracking samples of goods. When a sample is shipped to a facility, information regarding the origin of the sample, the date of arrival of the sample to the facility, the date that the sample was created, and conditions for keeping the sample viable are inputted into the system. Conditions for storing the sample can include humidity, temperature and other environmental factors, which are necessary to keep the samples viable. In a preferred embodiment, each sample is given an identification number. In a preferred embodiment, the system tracks delivery of the sample from the facility to its final destination with the customer.

An example of the present invention relates to the paper industry. A company in the paper industry has many paper mills located all across the country and around the world. Each mill produces a different grade of paper or the same grade of paper with different characteristics. Therefore, if this company were to sell all of its products from all of its mills it would need to have samples from every mill that it owns to provide to its customers. In an embodiment of the present invention Company A, a company in the paper industry has a storage facility for samples produced by it's mills. This company sells its paper products over the Internet. When a customer requests a sample of a paper product they inform Company A of their need for this sample. This request can be done over the phone or through the Internet, for example.

Company A has mills in locations 1, 2, 3 and 4. Each of the mills sends samples of their products to the Sample Facility of Company A. Along with the samples are sent dates of when the samples were made. The mill also submits information concerning the characteristics of the product. Such characteristics can include grade of paper, smoothness, opacity, brightness, print index, etc. The mill also sends a list of the environmental factors concerning storage of the product. All of this information can be sent electronically or through wireless means to the system of the present invention. The mill may choose to send rolls of the various grades of paper and the facility would have the capability to breakdown the roll into suitable sizes.

The system of the present invention is informed when a sample is requested. The system in a preferred embodiment, can inform the customer how long it will take for the sample to be delivered to the customer, or if a particular sample is not available. The samples are then sent to the customer along with sufficient information about the sample, such as origin and characteristics of the sample. At the same time the facility could provide collateral information to a potential customer about its capabilities and qualifications. In a preferred embodiment the company and/or mill whose samples were sent to the customer can then be informed that such samples were sent to that customer. The system of the present invention keeps track of when a sample is received from a mill and determines based on information received from the mill when a sample is no longer viable so that it should be destroyed. The system of the present invention keeps track of the number of samples stored and therefore instructs a user when samples are necessary and instructs a user when to replenish their supply at the facility. The system provides a logistics system to determine where the sample is located at all times.

In a further embodiment the facility can keep bulk quantities of product at the facility, and cut samples from the bulk quantity when the customers request the samples. For example, rolls of paper can be sent to the facility, and when a customer requests a sample of the paper, the samples can be cut from the rolls as necessary.

The system of the present invention can be used with most goods and preferably where the goods are located in several areas across the country or the world.

In an embodiment, the system of the present invention can store information regarding samples of many different companies.

1. A system for storing samples from multiple manufacturing locations comprising;
a warehouse or facility for storing samples of goods;
said facility storing perishable samples and providing appropriate environmental conditions necessary to keep said samples viable;
a database for storing information concerning the characteristics of said sample.

2. The system of claim 1 wherein said environmental conditions comprises; humidity, temperature, and other environmental factors which are necessary to keep the samples viable.

3. The system of claim 1 wherein a notification system notifies users when said samples are no longer viable.

4. The system of claim 1 wherein said samples are stored in bulk.

5. A computer system for samples comprising;
a database which comprises information of each sample;
said database containing information regarding the number of samples from a particular supplier of a particular type.

6. The system of claim 5 wherein said system informs a user to order more samples when said number of samples from a particular supplier of a particular good are less than a particular number of samples.

7. The system of claim 5 further comprising;
software for tracking the location of said samples.

8. The system of claim 5 wherein said information comprises the origin of said sample, date of arrival of said sample to said facility, date said sample was produced, and conditions for keeping said sample viable.

9. A method for storing samples comprising;
providing identification numbers to each sample;
storing information about said samples;
sending said sample to said customer along with information about said sample tracking delivery of said sample from a facility where said sample is stored to a final destination.

10. The method of claim 9 further comprising
informing a customer how long it will take for said sample to be delivered to said customer.

11. The method of claim 9 further comprising
informing a company that said samples of said company were sent to said customer

12. The method of claim 9 further comprising;
indexing when said sample is received from a company and determining based on information received from said company when a sample is no longer viable.

13. The method of claim 9 further comprising;
tracking number of samples stored and instructing a company when samples need to be replenished in said facility.

14. The method of claim 9 further comprising;
providing collateral material with said samples to potential customers of said facilities users, along with said sample.
